(19) United States
(12) Patent Application Publication
(10) Pub. No.: US 2006/0215632 A1
(43) Pub. Date: Sep. 28, 2006

(54) System and method for migrating messaging services between service platforms

(75) Inventors: Thomas Adams, Austin, TX (US); Yi Zhang, Austin, TX (US)

Correspondence Address: TOLER SCHAFFER, LLP, 5000 PLAZA ON THE LAKES, SUITE 265, AUSTIN, TX, 78746, US

(73) Assignee: SBC Knowledge Ventures, L.P., Reno, NV (US)

(21) Appl. No.: 11/086,795

(22) Filed: Mar. 22, 2005

(51) Int. Cl. H04L 12/66; H04L 12/56

(52) U.S. Cl. 370/352; 370/401

(57) ABSTRACT

The present disclosure provides a system and method configured to provide migration of messaging services. A messaging service is supported by a plurality of service platforms such as a first and a second platform. A request is received from a user to access the network service, and the request comprises identification information associated with the requesting entity, such as an originally requested/dialed telephone number. A migration table is referenced to determine if the requested number is under migration. If the number is not under migration normal routing occurs. If the number is under migration, a customer location database is accessed, routing information is retrieved from the custom-location database, and the new location of the mailbox is provided to routing equipment.

### BACKGROUND

Integrated messaging systems and services have become a useful, important, and often integral part of communications for many users. One benefit of integrated messaging services is that messages coming from many different communication devices can be sent to and retrieved from a central location. Communication devices having access to integrated messaging systems may include, for example, an e-mail client, a cellular phone, a home telephone, a personal digital assistant, a business phone, a pager, and a web browser.

While a true integrated messaging system includes several components, the Public Internet is considered by many to be a key enabler of modern messaging solutions. The Internet is easily accessible from many locations across the world. The Internet can be utilized to receive, move, and store information having an Internet Protocol (IP) format such as voice over Internet protocol (VoIP) communications. With a VoIP system, voices can be digitally recorded, moved across the Internet, stored, and replayed to a subscriber at any location having access to the Internet. Likewise, messages in other formats can be recorded and retrieved utilizing a voice system and a VoIP configuration—making VoIP systems and platforms an increasingly important part of a service provider's offering. In practice, service platforms, like those accommodating VoIP formats, may consist of one or more gateways that couple a messaging system to the Internet, routing equipment, input/output communication devices, and large data storage devices. Given the size and scope of integrated messaging systems and the cost and consequences of “downtime,” modifications to integrated messaging systems are costly and complicated often involving multiple interrelated components and interactions between these components.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 illustrates a simplified configuration of a messaging system;

FIG. 2 depicts a more detailed configuration of service platform routing system; and

FIG. 3 shows a flow diagram that illustrates a method of migrating subscribers service platforms.

### DETAILED DESCRIPTION OF THE DRAWINGS

As mentioned above, many service providers are beginning to utilize the Internet and a VoIP format to facilitate unified messaging applications. Many issues can arise when a VoIP service platform becomes full or cannot handle the bandwidth required for a growing client base. When a platform becomes full and users need to be moved to a new platform (migrated), significant problems may be encountered by the providers. In accordance with the teachings herein, modularized sets of interactions that allow the migration of portions of a customer voice-messaging database in a straightforward manner are disclosed.

A single call forwarding number may be utilized by tens of thousands of subscribers. For example, when a number is called and nobody answers the call, the call may be forwarded to a “community” call forwarding number, which routes the call to a service platform. The originally called number may be attached to the forwarded call as data. In practice, attaching the called party number may allow the centralized system to locate the called party's mailbox. When a system has mailboxes under migration, some calls may be forwarded to the call forwarding number of a service platform that does not service or have a mailbox for storing the call. This can cause a system failure and customer relations issues.

The teachings disclosed herein allow free and transparent migration of individual mailboxes or groups of mailboxes from one service platform to another service platform. In preferred embodiments, this migration occurs without a lapse in messaging service for the subscribers being migrated. The following discussion focuses on moving between service platforms in a VoIP messaging environment.

Though focused on this implementation of migrating between platforms, the teachings disclosed herein have broader application. Although certain embodiments are described using specific examples, it will be apparent to those skilled in the art that the invention is not limited to these few examples. Accordingly, the present invention is not intended to be limited to the specific form set forth herein, but on the contrary, it is intended to cover such alternatives, modifications, and equivalents, as can be reasonably included within the spirit and scope of the disclosure.

As indicated above, the present disclosure describes a system and method for migrating messaging service subscribers between servicing platforms. In operation, a messaging service may be supported by one or more service platforms such as a first and a second platform. A request may be received from a user to access the network service, and the request may include identification information associated with the requesting entity, such as an originally requested mail box and/or dialed telephone number. In practice, a migration table may be referenced to determine if the requested number is under migration. If the number is not under migration, normal routing may occur. If the number is under migration, a customer location database may be accessed, routing information may be retrieved from the customer location database, and the new location of the mailbox may be provided to routing equipment.

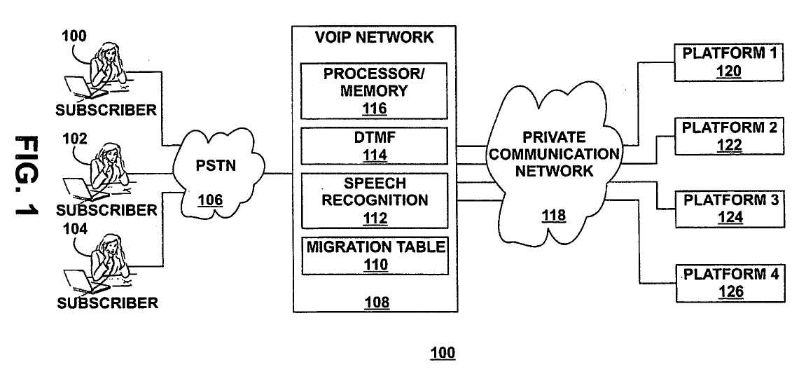

Referring to FIG. 1, an illustrated communication system 100 that includes a voice over IP network (VoIP) 108 is shown. The communication system 100 includes a plurality of representative subscribers 100, 102 and 104, coupled to a telephone network 106, such as a public switched telephone network (PSTN), which can utilize telephony protocols, IP protocols, and/or some other communication protocol, to couple callers 100-104 to VoIP network 108. VoIP network 108 may include among other things a processor with memory 116, a dual tone modulation frequency (DTMF) module 114, a speech recognition module 112, and a migration table 110.

The VoIP network 108 may be coupled to a private communication network 118, which may in turn couple subscribers 100-104 to any of the four depicted service platforms 120-126. Although only four platforms are illustrated, many additional platforms could be connected to the system without parting from the scope of the present invention. Likewise, public or private networks could be utilized to inter-connect users with service platform 120-126.

A subscriber's telephone number or other electronic address, such as an e-mail address, may serve as a call forwarding number, which may be used to help route an unanswered incoming call to an appropriate service platform. For example, if a subscriber is the addressee of an incoming communication and the subscriber does not answer or receive the communication, the communication may then be forwarded to a network-based messaging service and the address of the subscriber may be appended to the communication to help the messaging service route the forwarded communication to the proper repository—the one associated with the subscriber. Call data such as caller ID, the number dialed, e-mail address, passwords, etc. may be attached to the call as the call is forwarded to the service platform. As indicated above, such call data can be utilized by a messaging service and/or a network like VoIP network 108 to route the call to the appropriate platform and the appropriate mailbox. An incoming subscriber request for mailbox access to either retrieve information or to deposit information into the mailbox may be routed in a similar manner.

When mailboxes are not under migration, a call may be properly forwarded and routed utilizing the call data. If a system has mailboxes that are under migration, (i.e. the mailbox was previously supported at platform 120, and is now supported at platform 122), processor 116 may utilize instructions retrieved from memory to reference migration table 110 and to compare the call data to data in migration table 110. This comparison process may help determine if the requested mailbox location is under migration. If it is determined that the requested mailbox is under migration, a customer location database, which may be located for example in memory 116, can be accessed to help develop revised routing information and revised location information for the requested mailbox. Depending upon implementation detail, processor 116 may also add revised location and routing information to the call data and a given network and/or messaging service may route the call to the new mailbox location.

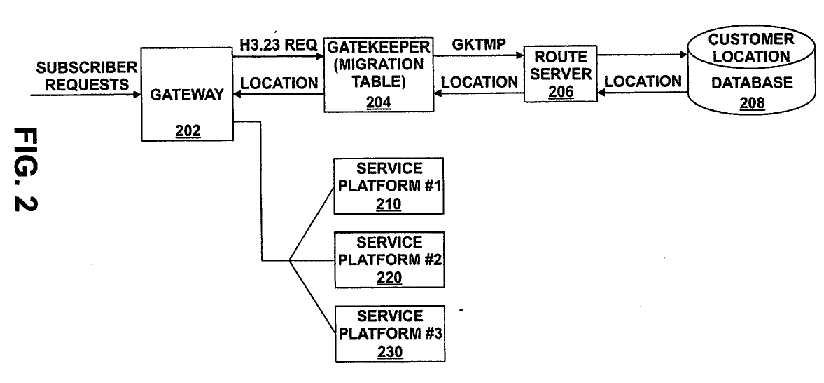

Referring to FIG. 2, a more detailed diagram of an illustrative system incorporating teachings disclosed herein is shown. The depicted system, which may be a VoIP-capable system, includes gateway 202, gatekeeper 204, route server 206, customer location database 208, first service platform 210, second service platform 220, and third service platform 230. Mailboxes of the various service platforms may be configured to receive and store many forms of digital data including e-mail, video mail, voice mail, text messaging, pictures, music, other content, web data, or any other form of digital communication. When a service provider moves a subscriber from the first service platform 210 to the second platform 220, an entry may be made in gatekeeper migration table 204 to indicate that the mailbox is under migration. As such, a “new” address for a migrating mailbox may then be entered and/or maintained in customer location database 208.

In practice, when a user or subscriber makes a request to access the services of a service platform, gateway 202 may receive the request. In some embodiments, the request for platform services will contain call data that is transmitted with the call. The requestor of mailbox access may be identified by some portion of the call data and the access request may also be authenticated by some portion of the call data. If additional information is needed, the requester may be prompted for the additional information by an interactive voice system. The call data may be requested and accepted by touchtone, dual tone multi-frequency input, speech recognition module (not shown), and/or some other modality of interface. In some situations, the call data may include the called number, the origination number (caller ID number) a redirecting number and/or a password.

As indicated above, gatekeeper 204 may store a migration table and utilize the call data to determine if the mailbox requested is on the migration list. In some cases, gateway 202 may utilize a specific protocol such as an H.323 protocol, to communicate with gatekeeper 204. H.323 protocol may facilitate transmitting data, audio, video, and other digital information. Gatekeeper 204 may also be configured to utilize a gatekeeper transaction message protocol (GKTMP) to communicate with route server 206, and route server 206 may be configured to query customer location database 208 in order to locate a revised routing and/or a current mailbox location.

The current address for a mailbox under migration may be listed in customer location database 208, and route server 206 may access the database to retrieve the revised location data. Route server 206 may in turn send the current mailbox address to gatekeeper 204, and gatekeeper 204 may then send it to gateway 202. With the current location information, gateway 202 may be able to route the user/subscriber request to the appropriate service platform.

Depending upon implementation details, gatekeeper 204 may have the ability to query route server 206 for certain destination numbers being migrated. As indicated above a call forwarding number (CFN) may be used to facilitate proper call routing. The CFN could be, for example, a called number, a redirecting number, an IP address, and/or some other location identifier. In practice, route server 206 may query customer location database 208 using an arbitrary protocol in order to determine a current location for a subscriber mailbox. The subscriber mailbox's current location may then be returned to gateway 204, and gateway 204 may use the information to make a proper H.323 setup to the new location.

For certain calls, such as a call without a known redirecting number but having a known called number, there may be insufficient information to automatically send the subscriber to the correct service platform. In such cases, gateway 202 may provide a unique H.323 “cause code,” which will allow gateway 202 to identify these calls and play a series of prompts to a requestor. For example, the caller may be asked to enter a telephone number associated with the network-based messaging platform. An appropriate receiving device may accept a subscriber's inputting of the telephone number, which may then be placed in a redirecting field of the call data. With the new information, the call may be sent to Gatekeeper 204, route server 206, and/or customer location database 208.

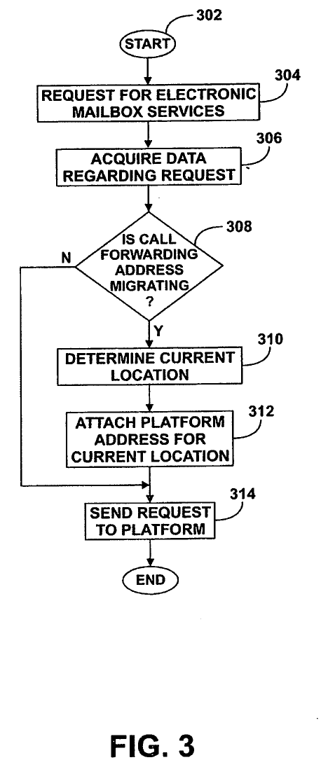

Referring to FIG. 3, an illustrated embodiment of a method of migrating subscribers between VoIP service platforms is provided. The method starts at 302 and proceeds to step 304 where a request for electronic mailbox services is received. The request may represent an unanswered call that has been forwarded to the mailbox, a subscriber retrieval request, and/or some other call. Call data regarding the call may be embedded in the request and stored at step 306. As indicated above, the call data could be caller identification numbers, the number called, personal identification numbers, and the like. If the call data does not contain enough information to determine if the call is under migration, the caller may be prompted for additional information. At decision step 308, it may be determined if the mailbox location is under migration by comparing the call data to data in a migration table.

If the requested mailbox is not under migration, the process may proceed to step 314 where the request is sent to the appropriate platform. If the requested electronic mailbox is under migration, the method may determine the current mailbox location at step 310. A new platform/mailbox address may be identified and attached to the request at step 312. And, the request may be sent to the appropriate platform at step 314. The process may proceed to stop at step 316. Though the steps are depicted in order, the process may be looped, reorganized, added to, deleted from, and/or otherwise modified without departing from the spirit of the teachings disclosed herein.

The above-disclosed subject matter is to be considered illustrative, and not restrictive, and the appended claims are intended to cover all such modifications, enhancements, and other embodiments that fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method for migrating messaging services comprising:
supporting a type of network service with at least a first platform and a second platform;
receiving a request to access the network service, the request comprising identification information associated with a requesting entity;
issuing a query to identify a platform supporting the network service, the request comprising identification information associated with a requesting entity; and
establishing a proper H.323 setup to facilitate communication with the identified platform.

2. The method of claim 1, wherein the identification information comprises a called number.

3. The method of claim 2, wherein the query includes a called number.

4. The method of claim 1, comprising receiving the request at a network service gateway.

5. The method of claim 1, wherein the network service comprises a voice mail service.

6. The method of claim 1, comprising maintaining a customer location database operable to indicate a platform supporting the network service for the requesting entity.

7. The method of claim 6, wherein the requesting entity is a subscriber of the network service.

8. The method of claim 6, comprising sending an H.323 request to an H.323 type gatekeeper in connection with identifying a proper platform supporting the network service.

9. The method of claim 6, comprising:
migrating support for the network service of the second platform; and
modifying the customer location database to indicate that the second platform supports the network service of the requesting entity.

10. A method for migrating messaging services comprising:
receiving a request to access a mailbox location previously supported at a first VoIP service platform;
referencing a migration table to determine if the mailbox location is on the first VoIP platform; and
facilitating communication between a requester and a second VoIP service platform if the mailbox location is no longer provided by the first VoIP platform.

11. The method of claim 10, further comprising identifying a requester of the access and accessing the mailbox if the requester is authorized.

12. The method of claim 10, wherein the requester is identified utilizing caller ID.

13. The method of claim 10, wherein the requester is identified utilizing a password.

14. The method of claim 10, wherein the migration table further comprises at least one call redirecting number.

15. The method of claim 10, wherein the requester is identified utilizing a called number.

16. The method of claim 10, wherein the mailbox location has an assigned telephone number.

17. The method of claim 10, wherein the communication comprises retrieval of a recorded voice mail

18. The method of claim 10, further comprising:
maintaining a voice mail service for a plurality of uses
utilizing H.323 facilities in connection with the voice mail service.

19. The method of claim 10, wherein the user is prompted for additional information.

20. The method of claim 10, wherein acquiring data further comprises acquiring a call forwarding number, a known subscriber number, and a caller identification number associated with the request.

21. A system for migrating voice mail subscribers comprising:
a memory maintaining voice mail storage locations for services under migration from a first platform to a second platform;
a gateway configured to receive voice mail access request from a user; and
a gatekeeper configured to receive a location request from the gateway and to access the voice mail memory to determine a proper platform supporting service for the user, the gatekeeper further operable to instruct the gateway to route the access request to the proper platform.

22. The system as in claim 21, wherein the user is identified by a called number.

23. The system of claim 21, wherein the location request comprises an H.323 request.

24. The system of claim 21, further comprising an authentication engine configured to allow access if the user is authorized.

25. The system of claim 21, wherein the voice mail storage locations are populated in a customer location database.

26. The system of claim 21, wherein the user is identified utilizing a received dual tone multi-frequency.

27. The system of claim 21, wherein the table further comprises at least one call redirecting number.

28. The system of claim 21, wherein the user is identified utilizing a called number.

29. The system of claim 21, wherein a given mailbox location has an associated telephone number.

30. The system of claim 21, wherein the gateway is further operable to initiate an H.323 setup to the proper platform.

31. The system of claim 21, wherein the gateway is further operable to prompt the user to input additional information if the gatekeeper does not provide a proper platform identifier.

32. The system of claim 21, further comprising a storage area network operable to save a voice mail message left for the user.
